(19) United States
(12) Patent Application Publication
(10) Pub. No.: US 2015/0019822 A1
(43) Pub. Date: Jan. 15, 2015

(54) System for Maintaining Dirty Cache Coherency Across Reboot of a Node

(71) Applicant: LSI Corporation, San Jose, CA (US)

(72) Inventors: Sumanesh Samanta, Bangalore (IN); Sujan Biswas, Bangalore (IN); Karimulla Sheik, Bangalore (IN); Thanu Anna Skariah, Bangalore (IN); Mohana Rao Goli, Bangalore (IN)

(73) Assignee: LSI Corporation, San Jose, CA (US)

(21) Appl. No.: 13/967,387

(22) Filed: Aug. 15, 2013

(30) Foreign Application Priority Data
Jul. 11, 2013 (CN) 823KOL2013

(51) Int. Cl. G06F 12/08

(52) U.S. Cl. CPC G06F 12/0815; G06F 12/0891
USPC 711/135

(57) ABSTRACT

Nodes in a data storage system having redundant write caches identify when one node fails. A remaining active node stops caching new write operations, and begins flushing cached dirty data. Metadata pertaining to each piece of data flushed from the cache is recorded. Metadata pertaining to new write operations are also recorded a corresponding data flushed immediately when the new write operation involves data in the dirty data cache. When the failed node is restored, the restored node removes all data identified by the metadata from a write cache. Removing such data synchronizes the write cache with all remaining nodes without costly copying operations.

### PRIORITY

The present application claims the benefit under 35 U.S.C. §119(a) of Indian Patent Application Serial Number 823/KOL/2013, filed Jul. 11, 2013, which is incorporated herein by reference.

### BACKGROUND OF THE INVENTION

While RAID (redundant array of independent disk) systems provide protection against Disk failure, direct attached storage redundant array of independent disk controllers are defenseless against server failure because they are embedded inside a server and will fail when the server undergoes planned or unplanned shutdown or reboot. Availability is improved with redundant nodes, each caching dirty data as write operations are received, and also mirroring the dirty data among each other to ensure redundancy. When a node fails, dirty data is flushed from the write cache in the redundant node to prevent data loss. Such caches can be gigabytes or terabytes in size. When the failed node comes back online, the failed node write cache must undergo a long rebuild process to synchronize the redundant write caches.

Consequently, it would be advantageous if an apparatus existed that is suitable for quickly synchronizing write caches in a multi-node system.

### SUMMARY OF THE INVENTION

Accordingly, the present invention is directed to a novel method and apparatus for quickly synchronizing write caches in a multi-node system.

In at least one embodiment of the present invention, redundant nodes in a data storage system identify when one node fails. A remaining active node stops caching new write operations, and begins flushing cached dirty data. Metadata pertaining to each piece of data flushed from the cache is recorded. Metadata pertaining to new write operations are also recorded when the new write operation involves data in the dirty data cache, and the newly written data is immediately flushed. When the failed node is restored, the restored node removes all data identified by the metadata from a write cache. Removing such data synchronizes the write cache with all remaining nodes without costly copying operations.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous advantages of the present invention may be better understood by those skilled in the art by reference to the accompanying figures in which:

FIG. 1 shows a block diagram of a system useful for implementing embodiments of the present invention;

FIG. 2 shows a flowchart of a method for handling write operations during a redundant controller failure;

FIG. 3 shows a flowchart of a method for synchronizing a write cache after a node failure;

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

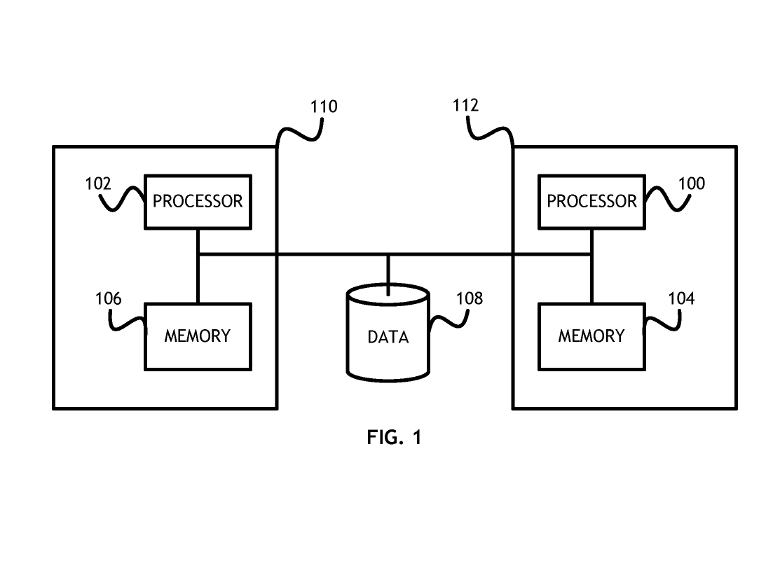

Referring to FIG. 1, a block diagram of a system useful for implementing embodiments of the present invention is shown. In at least one embodiment of the present invention, a system includes a first node 110 and a second node 112. Each of the first node 110 and second node 112 includes a processor 100, 102 connected to a memory 104, 106. Each memory 104, 106 is at least partially configured as a dirty cache for caching new data from write operations intended to overwrite data stored on one or more data storage devices 108. In at least one embodiment, the data storage device is a direct-attached storage (DAS) device. In at least one embodiment, the one or more data storage devices 108 are a redundant array of independent disks. Furthermore, in at least one embodiment, each memory 104, 106 is a solid state drive, capable of persistent storage when power is lost to the associated node 110, 112.

Each node 110, 112 services read requests and write requests to data in the data storage device 108. For improved system performance, each node 110, 112 caches the most popularly read data and the most frequently overwritten data in faster memory 104, 106 to reduce the number of times data must be read or written to the data storage device 108. While data in a read cache is merely replicated from the data storage device 108, data maintained in write caches (dirty data) may only be periodically flushed to the data storage device 108, and is therefore the only record of the most recent version of the dirty data. In a well-designed system, each of the nodes 110, 112 maintains a synchronized dirty cache such that the dirty cache in each memory 104, 106 is identical based on the most recent write operation to any one of the nodes 110, 112.

During normal operations, nodes 110, 112 may crash or otherwise lose power; for example, a first node 110 may lose power. Because, at the time the first node 110 failures, dirty data is not stored in a data storage device 108, the dirty data must be flushed from the second node 112 memory 104 to the data storage device 108 to prevent loss of data (in case of another failure, like node 112 or memory 104 too fails). As dirty data is flushed from the second node 112, the dirty data caches maintained on the first, failed node 110 and the second, operational node 112 become more and more de-synchronized.

In at least one embodiment, the second, operational node 112 processor 100 identifies when the first node 110 fails. When the second, operational node 112 processor 100 identifies that the first node 110 has failed, the second, operational node 112 processor 100 takes control of virtual and physical disks as necessary and continues to service read requests and write requests from other devices (not shown), but stops caching write requests and enters a “write through” mode wherein data is written directly to the data storage device 108. When a new write request is received, the second, operational node 112 processor 100 determines if the new write request would overwrite data in the dirty cache. If the second, operational node 112 processor 100 determines that the new write request would overwrite data cached in the dirty cache, the second, operational node 112 processor 100 stores metadata identifying the dirty data in the dirty cache that would be overwritten by the new write request, flushes the new write request without caching and deletes the dirty data that would have been overwritten from the dirty cache. Dirty data implicated by a new write operation is flushed immediately, regardless of the priority of such dirty data in a normal flushing procedure.

Furthermore, in at least one embodiment when the second, operational node 112 processor 100 has identified that the first node 110 has failed, the second, operational node 112 processor 100 begins flushing dirty data in the dirty cache to the data storage device 108. The second, operational node 112 processor 100 flushes dirty data according to some priority. In one embodiment, every time dirty data is flushed, the second, operational node 112 processor 100 stores metadata identifying the flushed, dirty data and deletes the dirty data from the dirty cache. Alternatively, the second, operational node 112 updates local metadata as soon as a flush is completed. Flushing dirty data from the dirty cache may take a substantial amount of time.

In a system according to at least one embodiment, when the first node 110 fails, the system stops caching write operations. When the first, failed node 110 returns to operability, the dirty cache in the first node 110 memory 106, which is persistent even during a power lose, only differs from the dirty cache in the second node 112 memory 104 in that the first node 110 dirty cache includes obsolete cached data.

In at least one embodiment, when the second, operational node 112 determines that the first, failed node 110 is operational again, the second node 112 sends to the first node 110 the stored metadata indicating all data that was removed from the dirty cache, or alternatively, the entire local metadata associated with the second node 112. The first node 110 then deletes all of the data indicated by the metadata from the dirty cache in the first node 110 memory 106. The dirty caches in both the first node 110 and the second node 112 are thereby synchronized without costly data transfers between the nodes 110, 112. Each node 110, 112 then begins receiving read requests and write requests and processing such requests normally.

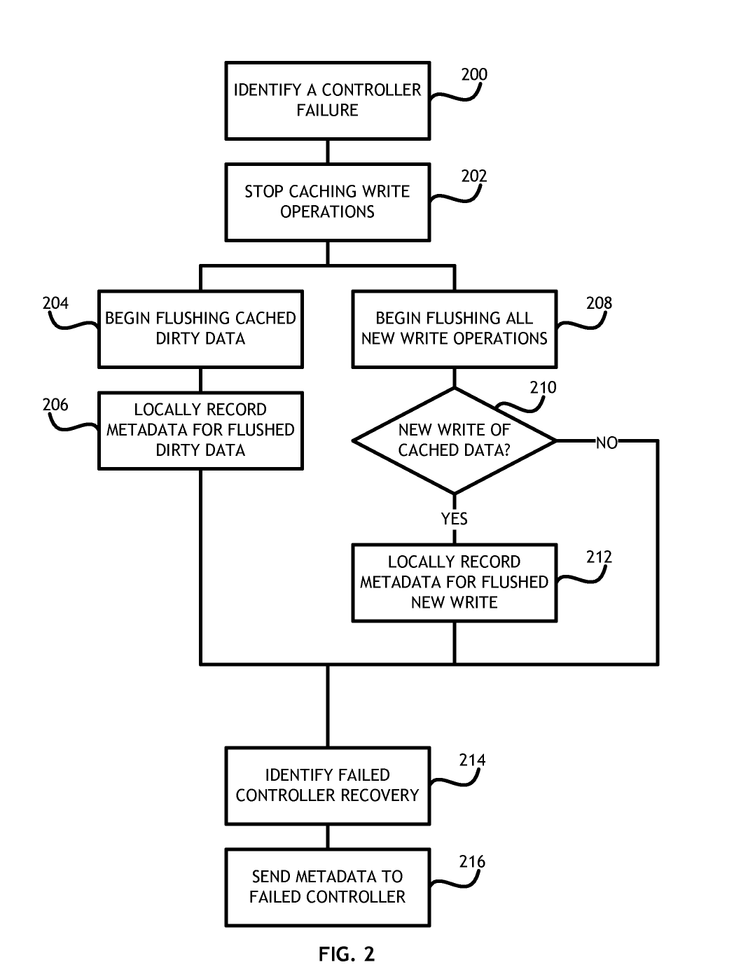

Referring to FIG. 2, a flowchart of a method for handling write operations during a redundant controller failure is shown. In at least one embodiment of the present invention, implemented in a data storage system having at least two controllers for redundantly caching write operations to frequently overwritten data, when a first controller fails a second controller identifies 200 that the first controller is no longer available. The second controller takes control of virtual and physical disks and stops 202 caching any new write operations; the second controller enters a write through mode whereby new write operations are written directly to a data storage device. In the context of at least one embodiment of the present invention, redundant controllers exist within a single node. In other embodiments, redundant controllers are individual controllers within redundant nodes.

Whenever the second controller receives a new write operation, the second controller flushes 208 the new data to a permanent data storage device, such as a redundant array of independent disks. The second controller determines 210 if the new write operation replaces data currently in a dirty cache maintained by the second controller. If the new write operation does replace data in the dirty cache, the second controller records 212 metadata identifying the data in the dirty cache that is being replaced and removes such data from the dirty cache and records the new write data directly to the permanent data storage device. The second controller continues to receive and flush 208 new write operations and record metadata until the first controller returns to operability.

Meanwhile, when the second controller is not servicing new write operations, the second controller begins flushing 204 dirty data from the dirty cache to the permanent data storage device. When dirty data is flushed 204, the second controller records 206 metadata identifying the flushed dirty data and removes the flushed dirty data from the dirty cache. Metadata in the context of the present application refers to any indicia useful for identifying portions of the dirty cache that have been flushed or no longer contain valid data between the time the first controller failed to the time the first controller became operational again. In at least one embodiment, metadata indicates memory block addresses.

When the first controller becomes operational again, the second controller identifies 214 that the first controller is operational and ready to process new write operations. The second controller then sends 216 recorded metadata to the first controller and after the first controller discards the data corresponding to the flushed data from the second controller, the first and second controllers beginning processing read requests and write requests according to normal operating procedures. Metadata sent 216 to the first controller could include all of the local metadata maintained by the second controller.

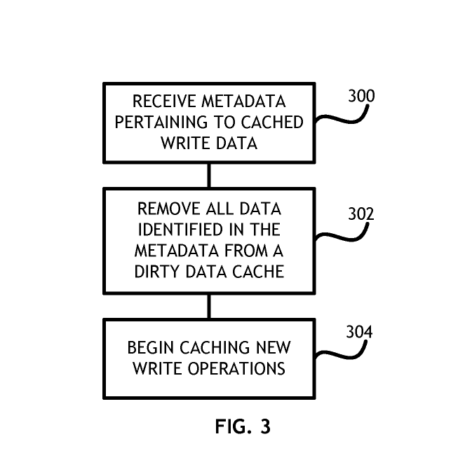

Referring to FIG. 3, a flowchart of a method for synchronizing a write cache after a node failure is shown. In at least one embodiment of the present invention, implemented in a data storage system having at least two nodes for redundantly caching write operations to frequently overwritten data, when a first node with a persistent memory housing a dirty cache fails and reboots, the first node receives 300 metadata from a second, continuously operational node indicating data flushed from the dirty cache while the first node was non-operational.

In at least one embodiment, the first node removes 302 all data in the dirty cache indicated by the metadata received 300 form the second node. The first node and second node dirty caches are thereby synchronized and the first node begins caching 304 new operations according to normal operating procedures.

A person skilled in the art will appreciate that while the embodiments described herein refer to a two node cluster, two nodes is merely exemplary and not limiting. Application to more than two nodes is conceived. Furthermore, multiple, redundant controllers within a single node, where each controller maintains a redundant dirty data cache, are also contemplated.

It is believed that the present invention and many of its attendant advantages will be understood by the foregoing description of embodiments of the present invention, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A data storage system comprising:
a first node comprising a dirty data cache;
a second node comprising a dirty data cache; and
a data storage element in data communication with the first node and the second node,
wherein:
the first node and the second node are configured to redundantly cache data from one or more write operations;
the second node is configured to:
identify a failure of the first node;
stop caching new write operations;
begin flushing all new write operations to the data storage element;
determine if a new write operation renders dirty data in the second node dirty data cache obsolete;
record metadata pertaining to obsolete dirty data;
identify that the first node is restored; and
send the metadata to the first node; and
the first node is configured to:
receive metadata from the second node; and
remove data identified by the metadata from the first node dirty data cache.

2. The data storage system of claim 1, wherein the second node is further configured to:
begin flushing dirty data from the second node dirty data cache to the data storage element; and
record metadata pertaining to dirty data flushed from the second node dirty
data cache to the data storage element.

3. The data storage system of claim 1, wherein the data storage element is a redundant array of independent disks.

4. The data storage system of claim 1, wherein the data storage element is a direct-attached storage device.

5. The data storage system of claim 1, wherein the data storage element is owned by the first node.

6. The data storage system of claim 5, wherein the second node is further configured to assume ownership of the data storage element.

7. The data storage system of claim 1, wherein:
the data storage element comprises two or more physical disks;
the first node is configured to own at least one physical disk of the two or more physical disks; and
the second node is configured to own at least one physical disk of the two or more physical disks.

8. The data storage system of claim 1, wherein:
the data storage element comprises two or more virtual disks;
the first node is configured to own at least one virtual disk of the two or more virtual disks; and
the second node is configured to own at least one virtual disk of the two or more virtual disks.

9. A node in a data storage system comprising:
a controller;
memory connected to the controller, at least partially configured as a dirty data cache; and
computer executable program code configured to execute on the controller,
wherein the computer executable program code is configured to:
identify a failure of a redundant controller;
stop caching new write operations;
flush all new write operations to a data storage element;
determine if a new write operation renders dirty data in the dirty data cache obsolete;
record metadata pertaining to obsolete dirty data;
identify that the redundant controller is restored; and
send the metadata to the redundant controller.

10. The node of claim 9, wherein the computer executable program code is further configured to:
flush dirty data from the dirty data cache to a data storage element; and
record metadata pertaining to dirty data flushed from the dirty data cache to the data storage element.

11. The node of claim 9, wherein the memory comprises a persistent memory element configured to retain data during a power lose.

12. The node of claim 11, wherein the memory comprises a solid state drive.

13. The node of claim 9, further comprising:
a second controller; and
a second memory connected to the second controller, at least partially configured as a dirty data cache,
wherein the second controller is configured to maintain a dirty data cache identical to the controller.

14. The node of claim 13, wherein identifying the failure of the redundant controller comprises identifying the failure of the second controller.

15. A method for synchronizing multiple write caches comprising:
identifying a failure of a redundant node;
stopping caching new write operations;
flushing all new write operations to a data storage element;
determining if a new write operation renders dirty data obsolete;
recording metadata pertaining to obsolete dirty data;
identifying that the redundant node is restored; and
sending the metadata to the redundant node.

16. The method of claim 15, further comprising:
flushing dirty data from a dirty data cache to a data storage element; and
recording metadata pertaining to dirty data flushed from the dirty data cache to the data storage element.

17. The method of claim 15, further comprising:
receiving the metadata; and
removing data identified by the metadata from a dirty cache in the redundant node.

18. The method of claim 17, further comprising resuming caching write operations.

19. The method of claim 15, further comprising assuming ownership of at least one virtual disk, wherein the at least one virtual disk was previously owned by the failed redundant node.

20. The method of claim 15, further comprising assuming ownership of at least one physical disk, wherein the at least one physical disk was previously owned by the failed redundant node.
